(19) United States
(12) Patent Application Publication
(10) Pub. No.: US 2020/0179219 A1
(43) Pub. Date: Jun. 11, 2020

(54) DEVICE AND METHOD FOR REDUCING INTRACRANIAL PRESSURE

(71) Applicant: The Regents of the University of California, Oakland, CA (US)

(72) Inventors: Johan Casper Grove Petersen, La Jolla, CA (US); Lonnie Petersen, La Jolla, CA (US); Alan Hargens, La Jolla, CA (US); Jeffrey Steinberg, La Jolla, CA (US)

(73) Assignee: The Regents of the University of California, Oakland, CA (US)

(21) Appl. No.: 16/623,355

(22) PCT Filed: Jun. 15, 2018
(86) PCT No.: PCT/US18/37944

§ 371 Date: Dec. 16, 2019

Related U.S. Application Data
(60) Provisional application No. 62/520,428, filed on Jun. 15, 2017.

(51) Int. Cl. A61H 9/00; A61G 10/02

(52) U.S. Cl. CPC A61H 9/0057; A61G 10/02; A61H 2201/501; A61H 2230/045; A61G 2203/46; A61H 2201/5071; A61H 2230/505; A61H 2201/0157; A61G 2203/34; A61H 2230/305

(57) ABSTRACT

A lower body negative pressure device is provided. The lower body negative pressure device includes an internal frame that surrounds a patient's lower body when the patient is in the lower body negative pressure device. The lower body negative pressure device includes a flexible cover covering the internal frame to receive the patient and provide a sealable environment. The lower body negative pressure device includes a pressure device coupled to the sealable environment to generate and regulate a negative pressure in the sealable environment when the sealable environment is sealed.

### CROSS-REFERENCE TO RELATED APPLICATIONS

The present application is a U.S. National Phase under 35 U.S.C. § 371 of International Application No. PCT/US2018/037944, filed Jun. 15, 2018, which claims priority to U.S. Provisional Patent Application No. 62/520,428, filed Jun. 15, 2017, the contents of which are incorporated herein by reference in their entirety.

### TECHNICAL FIELD

The present disclosure is generally related to treatment for elevated intracranial pressure, otherwise known as intracranial hypertension. In particular, embodiments of the present disclosure relate to treatment for intracranial hypertension by applying negative pressure in the lower body region.

### BRIEF DESCRIPTION OF THE EMBODIMENTS

Disclosed are systems, devices, and methods that relate to a lower body negative pressure device. A lower body negative pressure device may include an internal frame that surrounds a patient's lower body when the patient is in the lower body negative pressure device. The lower body negative pressure device may include a flexible cover covering the internal frame to receive the patient and provide a sealable environment. The lower body negative pressure device may include a pressure device coupled to the sealable environment to generate and regulate a negative pressure in the sealable environment when the sealable environment is sealed.

In embodiments, the pressure device may include a pressure release mechanism. When the negative pressure of the sealable environment reaches a threshold value, the pressure release mechanism may release air from the sealable environment.

In embodiments, the lower body negative pressure device may further include a biological feedback monitor. The biological feedback monitor may include a sensor to monitor the sealable environment. The biological feedback monitor may include a biosensor to monitor a biological metric of the patient. The biological feedback monitor may include the pressure device to regulate the negative pressure in the sealable environment. The biological feedback monitor may include a processor coupled to the sensor, the bio sensor, and the pressure device. The biological feedback monitor may include a non-transitory computer-readable medium coupled to the processor and storing instructions that, when executed, cause the processor to adjust the negative pressure in the sealable environment, using the pressure device, to a predetermined value when the biological metric reaches a threshold value.

In embodiments, the biological metric may include a heart rate, a mean arterial pressure, a cerebral perfusion pressure, or an intracranial pressure.

In embodiments, the sensor may include a temperature sensor, a pressure sensor, or a humidity sensor.

In embodiments, the lower body negative pressure device is transportable, such that an assembled lower body negative pressure device is used on the patient at a site of injury. The assembled lower body negative pressure device may also be transportable to an ambulance, a hospital bed, and a MRI device.

In embodiments, the internal frame may include two or more rods to support the flexible cover. The internal frame may also include two or more arches to support the flexible cover and to receive the two or more rods.

In embodiments, the internal frame may further include a base to receive the two or more arches.

In embodiments, the base may include a support extending perpendicularly from the base to prevent an upper body of the patient from entering the lower body negative pressure device.

In embodiments, the internal frame may be collapsible into a volume of about 1 cubic ft.

In embodiments, the flexible cover may include a first portion. The first portion may include a transparent material to view the patient. The first portion may also include a first coupling element.

In embodiments, the flexible cover may also include a second portion. The second portion may include a flexible material to translate properties of a surface in contact with the flexible material to a corresponding portion of the patient in contact the flexible material. The second portion may include a second coupling element that is couplable to the first coupling element. The flexible cover may conform to various midsections of different patients.

In embodiments, the first coupling element may be a pull tab part of a zipper and the second coupling element may be a slider part of a zipper.

In embodiments, the flexible cover may be removed from the internal frame by unzipping the first coupling element from the second coupling element.

In embodiments, the first portion further may include a non-permeable material that overlaps both the first coupling element and the second coupling element when the first portion is coupled to the second portion. When the lower body negative pressure device is pressurized, the non-permeable material may create a seal against the first coupling element and the second coupling element.

In embodiments, the second portion may be disposable.

In embodiments, the flexible cover may include one or more sealable ports to provide access to the patient.

Additional aspects of the present disclosure relate to a method for reducing intracranial pressure. The method may include assembling a lower body negative pressure device over a patient's lower body. The lower body negative pressure device may include an internal frame that surrounds a patient's lower body when the patient is in the device. The lower body negative pressure device may include a flexible cover covering the internal frame to provide a sealable environment. The lower body negative pressure device may include a pressure device to generate and regulate a negative pressure when the sealable environment is sealed. The method may also include securing the flexible cover around the patient to create a sealed environment. The method may include pressurizing the lower body negative pressure device using the pressure device to reduce intracranial pressure in the patient.

In embodiments, the method may further include releasing air from the sealable environment to reduce the negative pressure when the negative pressure of the sealable environment reaches a threshold value.

In embodiments, the lower body negative pressure device may further include a biological feedback monitor. The biological feedback monitor may include a sensor to monitor the sealable environment. The biological feedback monitor may include a biosensor to monitor a biological metric of the patient. The biological feedback monitor may include a processor coupled to the sensor, the bio sensor, and the pressure device. The biological feedback monitor may include the pressure device to regulate the negative pressure in the sealable environment. The biological feedback monitor may include a non-transitory computer-readable medium coupled to the processor and storing instructions that, when executed, cause the processor to adjust the negative pressure in the sealable environment, using the pressure device, within a range of values when the biological metric reaches a threshold value.

Additional aspects of the present disclosure relate to an apparatus. The apparatus may include an internal frame surrounding a patient's lower body when the patient is in the device. The apparatus may further include a flexible cover covering the internal frame to receive the patient and to provide a sealable environment. The apparatus may include a pressure device to generate and regulate a negative pressure when the sealable environment is sealed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various embodiments are disclosed herein and described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a lower body negative pressure device in accordance with one embodiment of the present disclosure.

FIG. 2 illustrates a fan and airway that can be used to induce negative pressure in accordance with one embodiment of the present disclosure.

FIG. 3 illustrates a lower body negative pressure device in accordance with one embodiment of the present disclosure.

FIG. 4 illustrates a perspective view of a lower body negative pressure device in accordance with one embodiment of the present disclosure.

FIG. 5 illustrates a perspective view of a lower body negative pressure device in accordance with one embodiment of the present disclosure.

FIG. 6 illustrates a perspective view of an internal frame in accordance with one embodiment of the present disclosure.

FIG. 7 illustrates a fastening mechanism in accordance with one embodiment of the present disclosure.

FIG. 8 illustrates a flexible cover in accordance with one embodiment of the present disclosure.

FIG. 9 is a flow chart illustrating example operations that can be performed to reduce intracranial pressure in accordance with various embodiments of the present disclosure.

FIG. 10 illustrates a lower body negative pressure device, in accordance with one embodiment of the present disclosure.

FIG. 11 illustrates an example computing module that may be used to implement features of various embodiments of the disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Brain trauma, stroke, cancer, infection, and other serious conditions can lead to an increase in intracranial pressure (ICP), which is defined as elevated pressure in the skull. As the pressure increases in and around the brain, a patient may demonstrate many symptoms, including vomiting, headache, nausea, increased blood pressure, and double vision. Too high of an ICP may induce the patient into a coma and could even lead to death.

Current treatment methods are limited to administering medications, hyperventilation, and elevating the head, all of which vary in effectiveness. Other treatment options include highly-invasive surgical procedures, which may place the patient at risk for infection, injury to brain tissue, anesthesia related complications, extended hospital stays, and may even result in death.

While there are existing lower body negative pressure chambers, such existing lower body negative pressure chambers are bulky, permanently attached to a table or bed, or otherwise integrated to a bed, and are difficult to climb into. These chambers require that a patient climb into the bed and place himself or herself within the lower body negative pressure chamber. Such a setup is not ideal for patients that are comatose or unable to move freely. Furthermore, current designs are too bulky, or otherwise immobile, and require many different parts and do not allow for disassembling and re-assembling the lower body negative pressure chamber, much less a lower body negative pressure chamber that can be quickly assembled or disassembled.

Embodiments of the apparatus, systems, devices, and methods disclosed herein provide a non-invasive technique for reducing intracranial pressure by using a lower body negative pressure device. The lower body negative pressure device may be a portable, stand-alone, MRI-compatible structure, or placed on a hospital bed or gurney. For example, the lower body negative pressure device may be used on an injured athlete at a sports event, the athlete may be transferred into an ambulance with the lower body negative pressure device, and arrive into a hospital bed with the same lower body negative pressure device. Alternatively, the lower body negative pressure device may be applied within an intensive care unit for patients with elevated intracranial pressure. The device may be MRI compatible, such that a patient may get an MRI scan while remaining in the lower body negative pressure device.

The lower body negative pressure device may include an internal frame that surrounds a patient. The internal frame may be lightweight and collapsible. The internal frame may include arches and rods that may fit together to form the frame with variations in the framework possible. The lower body negative pressure device may also include a flexible cover that covers the internal frame and creates a sealable environment within the flexible cover. The flexible cover may be made of different materials, and may include a transparent material for viewing into the device while in use. The flexible cover may have an opening to receive and secure a patient. In some embodiments, the lower body negative pressure device may include a pressure device to generate a pressure in the sealable environment. The lower body negative pressure device may include sensors to monitor the internal environment. In some embodiments, the lower body negative pressure device may include a rechargeable battery to power any electronics, such as, for example, the sensors and the vacuum.

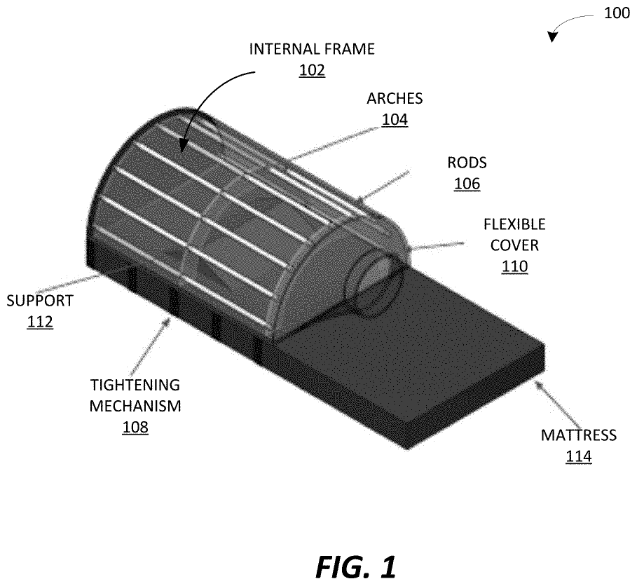

FIG. 1 illustrates a lower body negative pressure device in accordance with one embodiment of the present disclosure. Lower body negative pressure device 100 may be configured to use negative pressure around the lower body to displace blood and other fluids to the legs and pelvic area. This may reduce central venous filling and pressure, which is translated to the intracranial venous system, thereby reducing ICP. The negative pressure can be mild or moderate, as may be appropriate to reduce ICP.

As illustrated in FIG. 1, lower body negative pressure device 100 may be portable in design and easily brought to a patient lying in a hospital bed. In some embodiments, lower body negative pressure device 100 may include internal frame 102 that may support flexible cover 110 under pressure. In some embodiments, internal frame 102 may be constructed over the patient without having to remove the patient from the bed, allowing treatment of comatose or immobile patients. In some embodiments, lower body negative pressure device 100 may include one or more segments, such that a first part of lower body negative pressure device 100 is not coplanar with a second part of lower body negative pressure device 100. For example, lower body negative pressure device 100 may be configured to conform to a hospital bed that is able to elevate a patient's head, legs, etc., such that a first part of lower body negative pressure device 100 surrounding a patient legs is substantially flat, and a second part of lower body negative pressure device 100 surrounding a patient's waist is inclined at an angle corresponding to the angle of the hospital bed that is elevating the patient's head.

In some embodiments, lower body negative pressure device 100 may include one or more sensors (not shown), a pressure release mechanism (not shown), and a vacuum (not shown). Lower body negative pressure device 100 may include a control circuit to operate and control the one or more sensors, the pressure release mechanism, the vacuum, and other components. The control circuit may include a graphical user interface.

In embodiments, lower body negative pressure device 100 may use lightweight, non-toxic, easy-to-clean, MRI-compatible materials that may be collapsible, such as internal frame 102, and removable, such as flexible cover 110, as will be described herein. Lower body negative pressure device 100 may weigh about 1 lb to about 200 lbs, depending on the materials. Lower body negative pressure device 100 may also be easily disassembled and re-assembled. In an assembled state, lower body negative pressure device 100 may be about 2 cubic ft to about 35 cubic ft.

Lower body negative pressure device 100 may be assembled by placing a part of flexible cover 110 underneath a patient. Internal frame 102 may be constructed over the patient lying down on the part of flexible cover 110. The rest of flexible cover 110 may be coupled using a zipper, or similar attachment method, to the part of flexible cover 110 underneath the patient and cover internal frame 102, creating a sealable environment. Lower body negative pressure device 100 may be assembled at this point. The patient may be secured to lower body negative pressure device 100 by means of securing flexible cover 110 around the patient's waist, thereby creating a sealed environment. Flexible cover 110 may be secured using Velcro or similar material to cinch around the patients waist. Lower body negative pressure device 100 may be activated by applying negative pressure in the sealed environment.

Moreover, when lower body negative pressure device 100 is assembled and pressurized, or activated, the transportability, due in part to the stand-alone configuration and MRI-compatibility, as will be described herein, may allow a patient to use a lower body negative pressure device where the patient was injured and travel from an ambulance to a hospital bed and to an MRI device, without needing to remove lower body negative pressure device 100. Using lightweight, MRI-compatible materials, the lower body negative pressure device, unlike existing lower body negative pressure chambers, may be transported while in use to different locations. Similarly, the device 100 can be utilized on any standard hospital bed and does not require a specific hospital bed or gurney for use. In embodiments, lower body negative pressure device 100 may include an integrated rechargeable battery to power the pressure device generating negative pressure in lower body negative pressure device 100, the sensors in lower body negative pressure device 100, and any other components of lower body negative pressure device 100.

In some embodiments, internal frame 102 may be configured to support a pressure of about −30 mmHg for several hours at a time, although in other embodiments, other pressures can be supported for longer amounts of time. For example, in some embodiments internal frame 102 is configured to support pressures as low as, for example, −35 mmHg, −40 mmHg, −50 mmHg, or lower. By way of example only, internal frame 102 may be composed of material that does not promote the formation of moisture and is made of corrosion resistant material. This may be useful because lower body negative pressure device 100 is generally airtight, which could promote the growth of mold, which, in turn, could jeopardize the patient's health.

As illustrated, internal frame 102 may include arches 104 and rods 106 to support flexible cover 110 under pressure. This configuration, as described in further detail herein, may allow for quick and easy assembly and disassembly. As such, it significantly reduces the number of small and complicated components, which might otherwise pose problems when trying to sanitize or clean them.

As illustrated, arches 104 may be made out of polycarbonate and rods 106 may be made out of nylon. Other, preferably lightweight, materials can be used for arches 104 and rods 106, including other plastics and thermoplastics, carbon fiber, fiberglass, acrylic, aluminum or other metals or alloys, and other like materials. In embodiments, internal frame 102 may be made of inexpensive material so that parts are easily replaced and can be discarded after one-time use.

In some embodiments, arches 104 may receive rods 106 in outer edges of arches 104. For example, arches 104 may have cutouts located along the outer edges of arches 104 to receive rods 106. Arches 104 may be semi-circles, as illustrated, or semi-ovals, or other shapes in other embodiments. The geometry of arches 104 and the cutouts may provide improved support. For example, the cutouts may be symmetric such that the forces exerted by flexible cover 110 onto rods 106 inserted into arches 104 are also symmetric, which may provide greater support. Arches 104 may range in thickness from about 0.1 inches to about 1 inch. Arches 104 may extend across a range of about 3 ft to about 6 ft. Arches 104 may be about 2 ft to about 4 ft tall. A person of ordinary skill in the art will understand that other sizes and shapes may be used depending on the circumstances and patient dimensions.

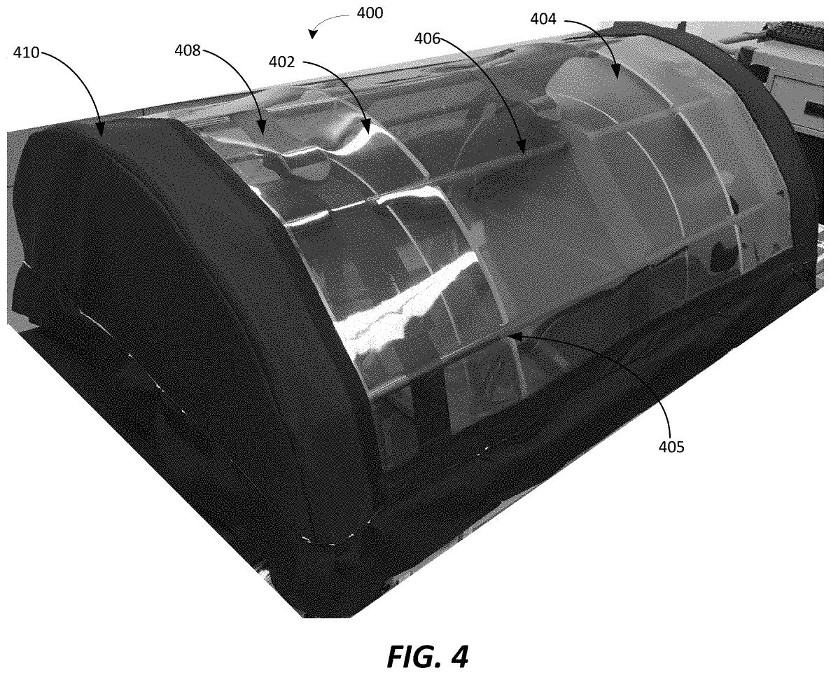

As illustrated, there may be three arches; however, a person of ordinary skill in the art will recognize that more or fewer arches may be used depending on different materials used for arches 104, the locations of arches 104, the pressure used for lower body negative pressure device 100, and other factors. For example, as illustrated in FIGS. 4-6, there are four arches. Referring back to FIG. 1, in embodiments, arches 104 may be collapsible. Arches 104 may each include one or more segments. In embodiments, one of the segments may slide behind a subsequent segment, such that when a given arch is collapsed, the segments appear stacked on top of each other. In other words, one segment includes one layer of the collapsed arch. In some embodiments, one of the segments may rotate behind a subsequent segment, such that when a given arch is collapsed, the segments appear stacked on top of each other. In embodiments, two or more segments may be on a same level when arches 104 are collapsed. Each segment may be coupled to neighboring segments. For example, a given segment may be coupled to the neighboring segments by pin, a piece of fabric, or another mechanism. The one or more segments may all be coupled together by a single material or mechanism.

In some embodiments, the far left and far right segment may be on the same layer, such that the given arch collapses into the area covered by two segments. A person of ordinary skill in the art will recognize that other configurations and mechanisms are possible to make arch 104 collapsible. Arches 104 may collapse into a volume that is less than about 1 cubic ft. The total weight of arches 104 may be about 1 lb to about 30 lbs, depending on the material. Collapsible arches 104 may reduce the amount of space required for storage and improve the portability of the disassembled lower body negative pressure device.

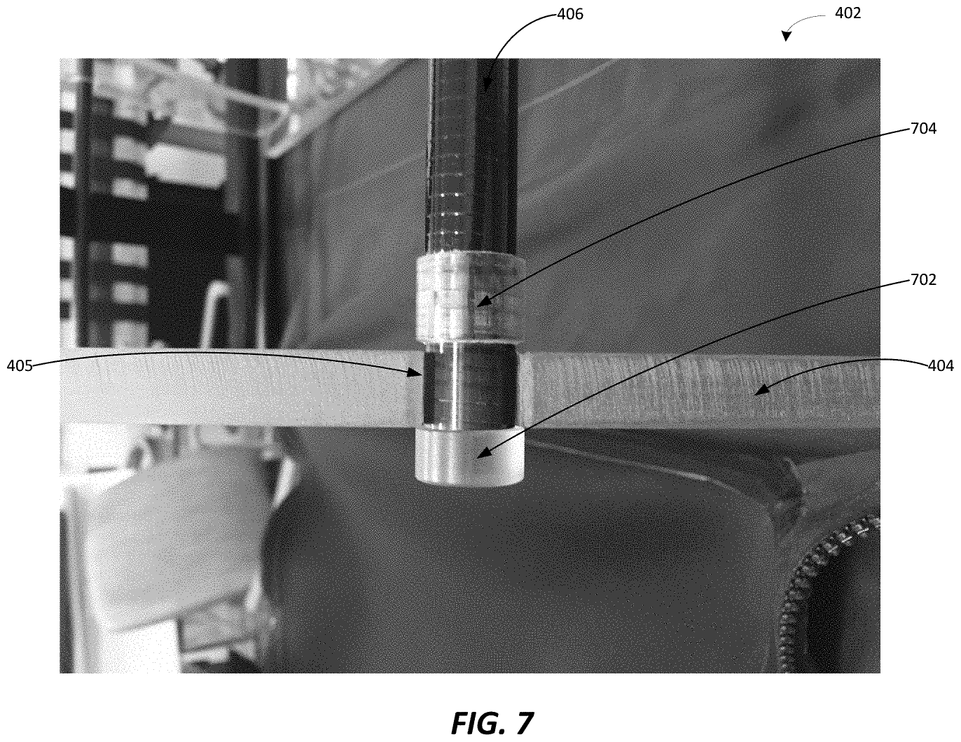

In embodiments, rods 106 supporting flexible cover 110 and placed into arches 104 may be circular, oval, or other shapes. Based on a shape of rod 106, the cutouts may vary correspondingly. In some embodiments, rods 106 may include a fastening mechanism configured to prevent movement of rods 106 once placed in arches 104. For example, as illustrated in FIG. 7, the fastening mechanism may include cap 702 that is coupled to the end of rod 406 to prevent movement of rod 406 along a longitudinal direction, or a direction parallel to its axis. Cap 702 may be made out of a plastic material. Cap 702 may be press fit, glued, integrated, or otherwise coupled to rod 406. Cap 702 may be removable with sufficient force.

In embodiments, rods 106 may include hinges to allow rods 106 to conform to different angles of lower body negative pressure device 100. Continuing the example above, a first part of lower body negative pressure device 100 may be substantially flat while a second part of lower body negative pressure device 100 may be at about a 30 degree upward angle. Rods 106 may have hinges that allow rods 106 to conform to both the first part and the second part of lower body negative pressure device 100, while lower body negative pressure device 100 generates negative pressure and comfortably secures the patient. In some embodiments, rods 106 may be flexible to accommodate for changes in a surface against which lower body negative pressure device 100 is resting. A person of ordinary skill in the art will recognize other mechanisms to allow rods 106 to accommodate planar changes to lower body negative pressure device 100.

In some embodiments, fastening mechanism may include sleeve 704 to further reduce movement of rod 406 in a longitudinal direction. Sleeve 704 may be made of the same material as cap 702. As illustrated, sleeve 704 may be positioned such that the distance between cap 702 and sleeve 704 is the width of arch 404. Sleeve 704 may be glued, integrated, or otherwise coupled to rod 406 at a given position. Sleeve 704 may be removable with sufficient force. In one example, the fastening elements may protrude from arches 104 with corresponding fastening elements cut out on rods 406, or vice versa, where the protruding fastening elements are integrated into rod 406 and the fastening elements cut outs are on arches 104.

Referring back to FIG. 1, in embodiments, rods 106 may be circular to improve the support of internal frame 102 from the negative pressure on rods 106. Rods 106 may be about 0.25 inches to about 3 inches in diameter. Rods 106 may range from about 2 ft to about 5 ft in length. A person of ordinary skill in the art will recognize that the sizes and the lengths may vary for different circumstances and patients.

In some embodiments, rods 106 may be coupled together by material, such as fabric, to prevent losing one of rods 106 and for additional support. Rods 106 may be coupled by the material such that an individual rod is laterally separated from a neighboring rod by a given distance. In embodiments, rods 106 may be collapsible. For example, rods 106 may telescope, such that a first end of a rod is larger than a second end, which is larger than a third end, etc. Rods 106 may separate out into segments that are all connected to each with a string or other material, where each segment is couplable to the neighboring segments. Rods 106 may be otherwise collapsible. Rods 106 may collapse into a volume of less than about 1 cubic ft. The total weight of rods 106 may be about 0.5 lbs to about 50 lbs. The collapsible rods may reduce the amount of space required for storage and improve the portability of the disassembled lower body negative pressure device

In embodiments, internal frame 102 may also include tightening mechanisms 108, such as, for example, ratchet straps, tie downs, cable ties, or the like, to help support arches 104 and rods 106. As illustrated, the tie down straps may couple lower body negative pressure device 100 to mattress 114, or another surface that is in contact with lower body negative pressure device 100.

In some embodiments, tightening mechanisms 108 may be in contact with rods 106. Tightening mechanisms 108 may be placed in between arches 104. Tightening mechanisms 108 may be tightened against rods 106 to secure rods 106 in place and provide additional structural support for internal frame 102. In embodiments, tightening mechanisms 108 may be coupled, or otherwise attached, to flexible cover 110.

In some embodiments, internal frame 102 may include a base to receive arches 104 to provide additional support for arches 104 and flexible cover 110. The base may be made of polycarbonate, or other lightweight materials, such as those used for arches 104 and rods 106. Arches 104 may fit into an outer edge of a base. The base may have cutouts on an outer edge to receive arches 104. The base may be in the shape of a rectangle, a circle, other shapes, or combinations of shapes. The base may be about 2 ft to about 4 ft wide by about 2 ft to about 5 ft long. The base may be about 0.25 inches or about 2 inches wide. A person of ordinary skill in the art will recognize that other sizes and shapes may be used depending on the circumstances.

The base may be collapsible or foldable, as described above with respect to arches 104 and rods 106. For example, the base may include one or more segments that may fold into itself or that may swivel into a minimized configuration where each segment is on a different layer. The base may collapse into a volume of less than about 0.5 cubic ft. The total weight for the base may be about 0.5 lbs to about 20 lbs. The collapsible, or foldable, base may reduce the amount of space required for storage and improve the portability of the disassembled lower body negative pressure device

The base may also include support 112 extending from the base towards rods 106. Support 112 may be couplable to the base. In some embodiments, support 112 may be integrated into, or couplable to flexible cover 110. As illustrated, support 112 may be a knee support wedge for the patient to place his or her legs onto. Support 112 may prevent the patient from being pulled into lower body negative pressure device 100 when negative pressure is generated in lower body negative pressure device 100. Support 112 may be shaped as a triangle, circle, or other shape. Support 112 may be about 2 cubic ft to about 5 cubic ft. In some embodiments, support 112 may be inflatable. A person of ordinary skill in the art will recognize that support 112 may be easily interchangeable to support patients of different sizes.

Support 112 may include a soft interior with a non-toxic, easy-to-clean exterior that is able to translate the properties of the soft interior to a corresponding part of the patient in contact with the exterior. The soft interior may be a fabric, such as, for example, cotton, latex, polyester fibers, memory foam, or other soft material. The exterior may include nylon, polymers, or other materials that are easy-to-clean, lightweight, and MRI-compatible.

Flexible cover 110 may be configured to cover internal frame 102, receive a patient, and create a sealable environment. In some embodiments, flexible cover 110 may be nonpermeable, semipermeable, or airtight. In embodiments, flexible cover 110 may have an opening to receive a patient. The opening may be configured to form a seal around the patient when the patient is secured to the lower body negative pressure device 100. The opening may be made of neoprene, rubber, Velcro®, and other flexible material. For example, an opening made of neoprene with Velcro® attached to the exterior may be able to stretch around different sized patients, and form a seal with the Velcro®.

Flexible cover 110 may form a sealable environment around internal frame 102 when a patient is secured to lower body negative pressure device 100, as will be described herein. In other words, flexible cover 110 provides a sealable environment around internal frame 102 when the patient is in lower body negative pressure device 100. Flexible cover 110 may be configured to withstand about −31.03 mmHg or less for up to eight hours at a time. By way of example only, flexible cover 110 may be made of material that includes clear cast acrylic, clear vinyl sheet, taslan, ripstop nylon, nylon webbing, neoprene, vinyl windows, pvc, vinyl coated polyester, oxford sheeting, and other materials. In some embodiments, the materials may be coated in one or more of a non-toxic, non-flammable, waterproof, water repellant, and other materials. For example, the coating may be urethane, silicon, etc. In embodiments, flexible cover 110 may include one or more materials on different parts of flexible cover 110, such as, for example, nylon on a first part of flexible cover 110, vinyl windows on a second part of flexible cover 110, neoprene on a third part of flexible cover 110, and so on.

In embodiments, flexible cover 110 may include ports to provide access to a patient. For example, the ports may be configured to receive needles, tubes, electrical wires, or the like coupled to the patient. In embodiments, the ports may be sealable by receiving medical apparatuses, such as, for example, needles, tubes, and the like, to create a seal. The ports may be sealable through the use of an overlapping piece of non-permeable material around the ports that may tighten around the medical apparatuses when negative pressure is applied, thereby providing a seal. In embodiments, the ports may include access for a pressure device (e.g., vacuum line). In some embodiments, the ports may include a glove-box, similar to those used in clean rooms that isolate the sealable environment from the outside environment, allowing a medical professional to manipulate devices within lower body negative pressure device 100 without having to remove the patient from lower body negative pressure device 100.

In embodiments, flexible cover 110 may be quickly and easily removable. In some embodiments, flexible cover 110 may include a first portion and a second portion. The first portion and the second portion may be coupled together by various mechanisms, such as, for example, a zipper, Velcro®, magnets, buttons, ties, or other mechanisms. For example, flexible cover 110 may be quickly and easily removed by unzipping flexible cover 110 and removing it from internal frame 102. The first portion may include a first coupling element and a transparent material in the center of the first portion that allows a doctor, other medical personnel, or other people to monitor or view the patient's lower extremities without having to remove the patient from lower body negative pressure device 100. The first portion may include one or more materials in different parts of the first portion, as will be described herein.

The second portion may include a second coupling element corresponding to the first coupling element and a flexible material to translate properties of a surface (e.g., a mattress) in contact with the flexible material to a corresponding part of the patient in contact with the flexible material. For example, mattresses may be designed to prevent bedsores and compression injuries to the patient, and the second portion may translate these properties to the patient, such that the patient may be inside the lower body negative pressure device for many hours. The second portion may include one or more materials in different parts of the second portion, as will be described herein. In some embodiments, the opening to receive the patient may be a part of the first portion, the second portion, or may be detachable. In embodiments, the opening to receive the patient may be a part of the first portion and second portion, as will be described herein.

In embodiments, the first portion of flexible cover 110 may cover a top side of lower body negative pressure device 100. For example, using internal frame 102 as a reference, the first portion of flexible cover 110 may be in contact with arches 104 and rods 106. The first portion may include a non-permeable, transparent material (e.g., clear vinyl window) near the center of the first portion. This may allow people to see the patient without needing to remove the patient from lower body negative pressure device 100. The first portion may include non-permeable material (e.g., ripstop nylon) that is coupled to the transparent material to ensure non-permeability throughout the first portion. The transparent material may be stitched, glued, or otherwise coupled to the non-permeable material.

In some embodiments, the first portion of flexible cover 110 may include an area to receive and secure the patient, thereby creating a sealed environment in lower body negative pressure device 100. The area to receive and secure the patient may include neoprene, rubber, or other flexible, non-toxic, lightweight, easy-to-clean, MRI-compatible materials. The flexibility of the material may allow different sized patients to use the same lower body negative pressure device. In some embodiments, the first portion may be disposable. The first portion of flexible cover 110 may be substantially rectangular, circular, or other shapes. The first portion of flexible cover 110 may cover an area of about 5 square ft to about 20 square ft. The first portion of flexible cover 110 may be under about 5 lbs. A person of ordinary skill in the art will recognize that other sizes, shapes, and materials may be used depending on the patient's needs.

In some embodiments, the second portion (not shown) of flexible cover 110 may cover a bottom side of lower body negative pressure device 100. For example, using the base as a reference point, the second portion may be in contact with the base. The second portion may be in contact with the patient as well as in contact with the surface on which the patient is lying down (e.g., mattress 114). The second portion may include a flexible, thin, non-permeable material (e.g., ripstop nylon). In some embodiments, the second portion may be configured to be flexible, which may allow the beneficial properties of mattress 114, or a bed, to translate through the second portion and benefit the patient. For example, mattress 114 may be configured to alleviate bedsores, especially for those patients that are comatose or immobile. The second portion may translate the properties of mattress 114 such that the second portion in contact with mattress 114 is able to alleviate bedsores as well.

In some embodiments, a third portion (not shown) may be placed on the inside of the second portion. In embodiments, the third portion may be disposable. For example, the third portion may be a thin piece of sanitary paper separating the patient from the second portion. In embodiments, the third portion may be removable and washable, such that another person can quickly remove, clean, and re-insert the third portion. In some embodiments, the third portion may be couplable to the second portion. The third portion may be integrated into the second portion, such that the second portion may be disposable or removable and washable.

In embodiments, the second portion may include support 112, such as foam or padded material, as described above. When lower body negative pressure device 100 is applied to create a semi-airtight device, the pressure can cause the patient to be pulled into lower body negative pressure device 100. To prevent the patient from sliding, support 112 may provide support to prevent the patient from being pulled into lower body negative pressure device 100, as described above.

In some embodiments, the second portion of flexible cover 110 may include an area to receive and secure the patient, thereby creating a sealed environment in lower body negative pressure device 100. This area may correspond to the area of the first portion to receive and secure the patient. The area to receive and secure the patient may include neoprene, rubber, or other flexible, non-toxic, lightweight, easy-to-clean, MRI-compatible materials. The flexibility of the material may allow different sized patients to use the same lower body negative pressure device. In some embodiments, the second portion may be disposable. In embodiments, the second portion may function as a fitted bed sheet to go over mattress 114. The second portion of flexible cover 110 may be substantially rectangular, circular, or other shapes. The second portion of flexible cover 110 may cover an area of about 5 square ft to about 20 square ft. The second portion of flexible cover 110 may be under about 5 lbs. A person of ordinary skill in the art will recognize that other sizes, shapes, and materials may be used depending on the patient's needs.

The first portion and the second portion of flexible cover 110 may be coupled together by various mechanisms, such as, for example, a zipper, Velcro®, magnets, buttons, ties, or the like, as described above. For example, the first portion may have a first coupling element that is a pull tab part of a zipper and the second portion may have a second coupling element corresponding to the first coupling element that is a slider part of a zipper. In another example, the first portion and the second portion may fuse at the level near the patient's midsection. After coupling the first portion to the second portion over internal frame 102, lower body negative pressure device 100 may be ready to secure a patient to lower body negative pressure device 100. When the negative pressure is applied to the sealed environment, extra material, from either the first portion or the second portion, may overlap onto the coupling elements of the first portion and the second portion to create a seal over the coupling elements because the coupling elements may inadvertently leak air without the seal.

When the first portion and the second portion are coupled together, the areas of the first and second portion configured to receive and secure the patient may include a tapered flexible opening to secure a patient to lower body negative pressure device 100. When a patient is in lower body negative pressure device 100, the tapered flexible opening may surround a midsection region of the patient. The tapered flexible opening may be made of, for example, neoprene on an inside and a Velcro material on the outside. Continuing the example, a Velcro® band may be used to securely attach the patient to lower body negative pressure device 100 and create a sealed environment. One or more medical devices, such as, for example, needles, pulse oximeter, colostomy bags, and the like, may be guided against the tapered flexible opening and secured into a position when the Velcro® band is used to securely attach the patient to lower body negative pressure device 100. This may allow the medical devices to access the patient while providing a seal around the patient. For example, a needle may need to be inserted into a patient. The tube connecting the needle to medicine may be guided on the inside of the tapered flexible opening, and the tube and the patient may be secured to create a sealed environment, thereby allowing the patient to receive medication while inside lower body negative pressure device 100.

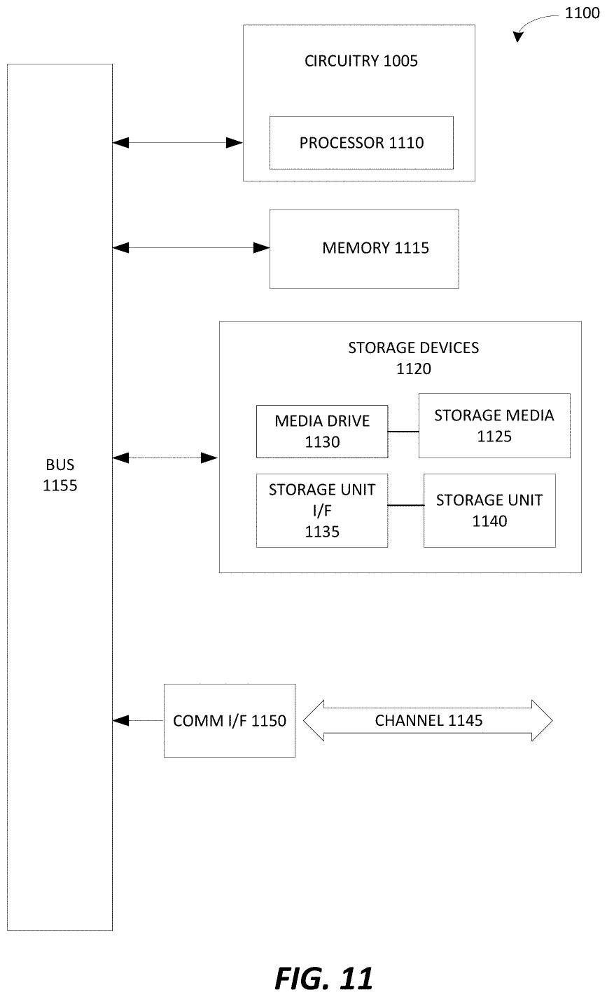

In some embodiments, the one or more sensors of lower body negative pressure device 100 may monitor various metrics through a control circuit. The control circuit may include one or more processors and use components as described herein, such as the example computing module of FIG. 11. The one or more sensors may include a pressure sensor, a temperature sensor, a humidity sensor, and other sensors. The pressure sensor may detect a pressure inside lower body negative pressure device 100. The temperature sensor may detect the temperature inside lower body negative pressure device 100. The humidity sensor may detect a humidity inside lower body negative pressure device 100.

The one or more sensors may be coupled to the control circuit to alert a user that one or more of the metrics is outside a threshold value. For example, the control circuit may alert a user when the negative pressure falls below −30 mmHg. In some embodiments, the pressure release mechanism of lower body negative pressure device 100 may open to allow inflow of air from outside the lower body negative pressure device 100 when the pressure is outside the threshold value. Continuing the example above, when the negative pressure falls below −30 mmHg, the pressure release mechanism may open from lower body negative pressure device 100. For example, the pressure release mechanism may be a check valve controlled by the control circuit to decrease the amount of negative pressure. In other embodiments, the pressure release mechanism may be mechanical and be constructed to stay within −30 mmHg. The pressure release mechanism may allow changes in negative pressure on the scale of 0.01 mmHg, 0.1 mmHg, 1 mmHg, or other amounts.

In some embodiments, internal frame 102 and flexible cover 110 may be integrated into a unitary, collapsible piece. For example, lower body negative pressure device 100 may use mechanisms similar to pop-up tents. The mechanisms may include elastic objects and a fastening mechanism. The elastic objects (e.g., springs) may compress lower body negative pressure device 100 into a smaller size. The fastening mechanism (e.g., straps, latches, and the like) may keep lower body negative pressure device 100 in this collapsed state when engaged. The fastening mechanism may be disengaged to expand lower body negative pressure device 100 into a ready-to-use state. Continuing the example above, with reference to internal frame 102, the collapsible arches 104 and the collapsible rods 106 may use springs, in part, to couple the one or more segments of arches 104 and rods 106 together, respectively. The spring may allow arches 104 and rods 106 to be compressed, and a latch may be engaged to keep arches 104 and rods 106 in a compressed state. Upon disengaging the latch, arches 104 and rods 106 may expand into a ready-to-use state. Flexible cover 110 may be configured to be loose when in a compressed state and taut when in a ready-to-use state. A person of ordinary skill in the art will recognize that other mechanisms may be used to provide a unitary, collapsible lower body negative pressure device.

When lower body negative pressure device 100 is not in use, lower body negative pressure device 100 may be disassembled for easy storage in the hospital or even alongside a patient bed outside a hospital facility. When disassembled, the volume of lower body negative pressure device 100 may be about 1 cubic ft to about 3 cubic ft. The collapsible and lightweight features may improve the portability of lower body negative pressure device 100.

In some embodiments, lower body negative pressure device 100 may be disassembled by removing flexible cover 110. Internal frame 102 may be disassembled next. Because lower body negative pressure device 100 may be easily set up and disassembled, this allows for lower body negative pressure device 100 to be easily moved and assembled even outside of a hospital setting, such as a gurney of an ambulance, in makeshift tents in a war situation, beds at a patient's home, sports arenas, public venues, etc. Because the disclosed lower body negative pressure device is set up for quick, easy assembly, lower body negative pressure device 100 may be used as a first line of treatment on-site to provide immediate medical attention to a person.

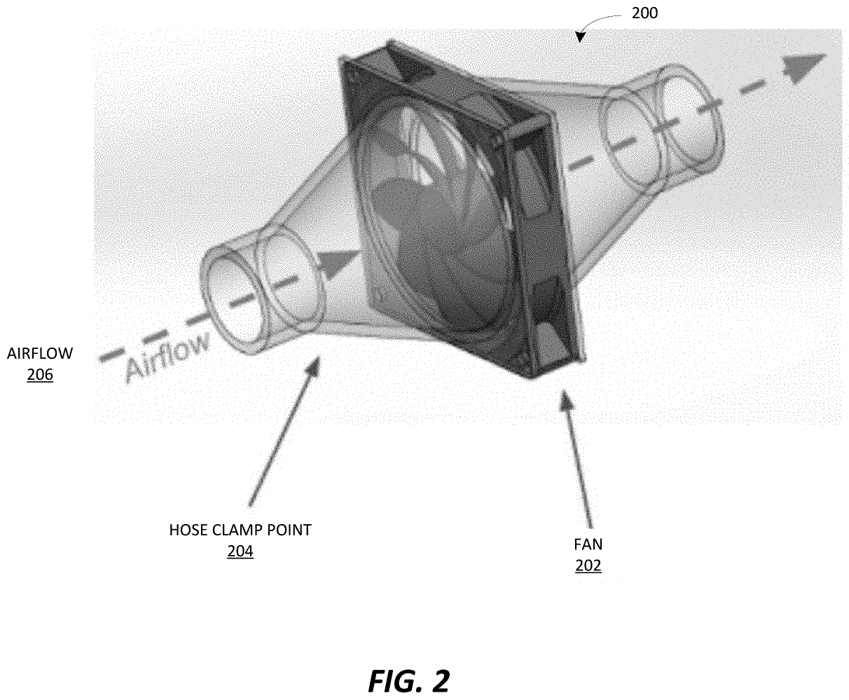

FIG. 2 illustrates a pressure device that can be used to induce negative pressure in accordance with one embodiment of the present disclosure. Pressure device 200 may include fan 202 and an airway 206. A hose may be clamped onto hose clamp point 204 to couple pressure device 200 to lower body negative pressure device 100. Although not shown, embodiments may also include a flow meter and electronic pressure transducer to measure the airflow and the negative pressure in lower body negative pressure device 100. Both may relay information to a control circuit that determines the airflow and pressure and provides this information to a graphical user interface for live monitoring of conditions inside lower body negative pressure device 100. In some embodiments, the pressure sensor may be, for example, a PX26-005GVB atmospheric differential pressure sensor, and the flow meter may be a PC fan with an internal hall effect sensor. Both the pressure sensor and the flow meter may be mounted between two adapters for a connection in line with pressure device 200. A person of ordinary skill in the art will recognize that other sensors and flow meters and other configurations may be used to detect and generate pressure in a lower body negative pressure device. For example, pressure device 200 may be a vacuum pump that is used to generate the negative pressure.

By way of example only, pressure device 200 may be configured such that there is pressure reaching about −30 mmHg within the sealed environment of flexible cover 110. In embodiments, the negative pressure may be variable in increments such as, for example, in about 0.1 mmHg increments to about 5 mmHg increments. Furthermore, the system may also require continuous air flow of a minimum of, for example, about 5 cubic ft per minute (CFM) to prevent heat and humidity from building up. This is based on an average human heat output of about 350 BTU/hr in a space of about 22 cubic ft, where the enthalpy of dry air at about 70 degrees Fahrenheit is about 16.8 BTU/lb and the density of air is about 0.07711 lb/ft. In embodiments where a flexible plastic casing instead of a hard shell plastic casing is used, indicating an imperfect hermetic seal, the vacuum flow rate may be about 50 to about 60 CFM.

Furthermore, lower body negative pressure device 100 must maintain the pressure inside the device to relieve pressure in the patient's skull. The pressure device 200 should be maintained at a certain flow rate to provide a consistent pressure difference between the inside the sealed environment and the atmosphere. Assuming that lower body negative pressure device 100 does not have a perfect hermetic seal, lower body negative pressure device 100 may require pressure device 200 with a greater flow rate (e.g., about 85 CFM) to ensure that that lower body negative pressure device 100 reaches and maintains the desired negative pressure (e.g., about −30 mmHg). In some embodiments, pressure device 200 may be noiseless or have reduced noise, as may be appropriate in a hospital.

In some embodiments, pressure device 200 may be integrated into lower body negative pressure device 100, for example, into a region below where the patient's feet may rest. The integrated vacuum region may couple pressure device 200 to the sealed environment. The airway of pressure device 200 coupled to the sealed environment may incorporate the sensors described above. The integrated vacuum region may be designed to reduce the noise from the vacuum. The integrated vacuum region may be an enclosed space separate from flexible cover 110, but still in contact with flexible cover 110. The integrated vacuum region may be enclosed with similar materials to internal frame 102 and flexible cover 110. The integrated vacuum region may take up to about 1 cubic ft to about 6 cubic ft.

In embodiments, pressure device 200 may be entirely separate from lower body negative pressure device 100, for example, in a sealed box. Whether pressure device 200 is integrated or not, pressure device 200 is enclosed to mitigate the amount of noise and external airflow pressure device 200 causes. For example, in an intensive care unit section of a hospital, an enclosed pressured device will not push up dust and other contaminants into the air in a sensitive environment.

Pressure device 200 may include a feedback loop to determine if pressure falls below an acceptable level and to maintain a given pressure in the system. In some embodiments, if the pressure inside lower body negative pressure device 100 is too negative, the device may be configured to reduce the output of fan 202 or adjust a pressure mechanism, such as a check valve, to maintain pressures within the predetermined value. In some embodiments, in case of an emergency, pressure inside the device can be equalized quickly, and the device can be deconstructed and removed from the patient in approximately less than a minute. The first portion and the second portion of flexible cover 110 may be decoupled to expose internal frame 102, which may be removed to provide immediate access to the patient.

In some embodiments, pressure device 200 may include a feedback loop based on a biological metric. The biological metric may include an intracranial pressure, a mean arterial pressure, a heart rate, or other biological metrics. The biological metric may affect or otherwise correspond to the intracranial pressure. In embodiments, the control circuit of pressure device 200 may be coupled to one or more biological sensors on the patient monitoring biological metrics. The biological sensors may include pressure sensors, temperature sensors, accelerometers, flow meters, and other sensors to measure blood pressure, heart rate, movement, and other metrics. For example, a medical professional may want to keep a patient's intracranial pressure below 20 mmHg. The control circuit may monitor a patient's intracranial pressure through the one or more biological sensors, and if the intracranial pressure goes over 20 mmHg, the control circuit may adjust pressure device 200 to further reduce the negative pressure (e.g., −25 mmHg to −28 mmHg) in the sealed environment.

In some embodiments, pressure device 200, any sensors, both monitoring lower body negative pressure device 100 and the patient, and the control circuit, may be powered by a standard wall outlet. In embodiments, lower body negative pressure device 100 may include a battery to power the electronics described above for a given amount of time. In embodiments, the battery may be rechargeable. The battery may be integrated into lower body negative pressure device 100; for example, the battery may be located in the integrated vacuum region.

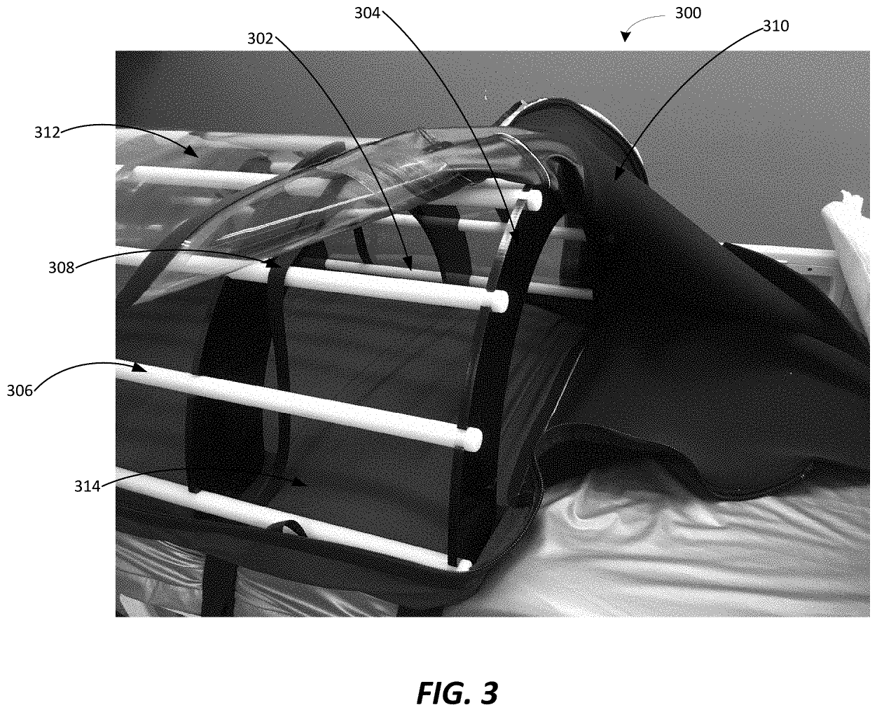

FIG. 3 illustrates a perspective view of a lower body negative pressure device in accordance with one embodiment of the present disclosure. As illustrated, lower body negative pressure device 300 may include internal frame 302 and flexible cover 310. Internal frame 302 that supports flexible cover 310 may include arches 304, rods 306, and straps 308. Flexible cover 310 may cover internal frame 302. As illustrated, flexible cover 310 may include a first portion 312 and a second portion 314. As illustrated, arches 304 may be a metallic material. Arches 304 may include cutouts to receive rods 306. As illustrated, rods 306 may be a nylon material. Straps 308 may wrap around internal frame 302.

Flexible cover 310 may provide a semi-permeable surface that covers internal frame 302. Flexible cover 310 may include a first portion 312 and a second portion 314. First portion 312 may include transparent material in the center of first portion 312. The transparent material may allow someone to view the patient inside lower body negative pressure device 300 without having to remove the patient. As illustrated, the transparent material may be coupled to a semi-permeable fabric. Second portion 314 may be made of a semi-permeable fabric and otherwise be similar to the semi-permeable fabric portion of first portion 312. Second portion 314 includes an opening to secure the patient to the lower body negative pressure device via the patient's waist or pelvic region. As illustrated, the opening can be tightened, or cinched, to form a seal.

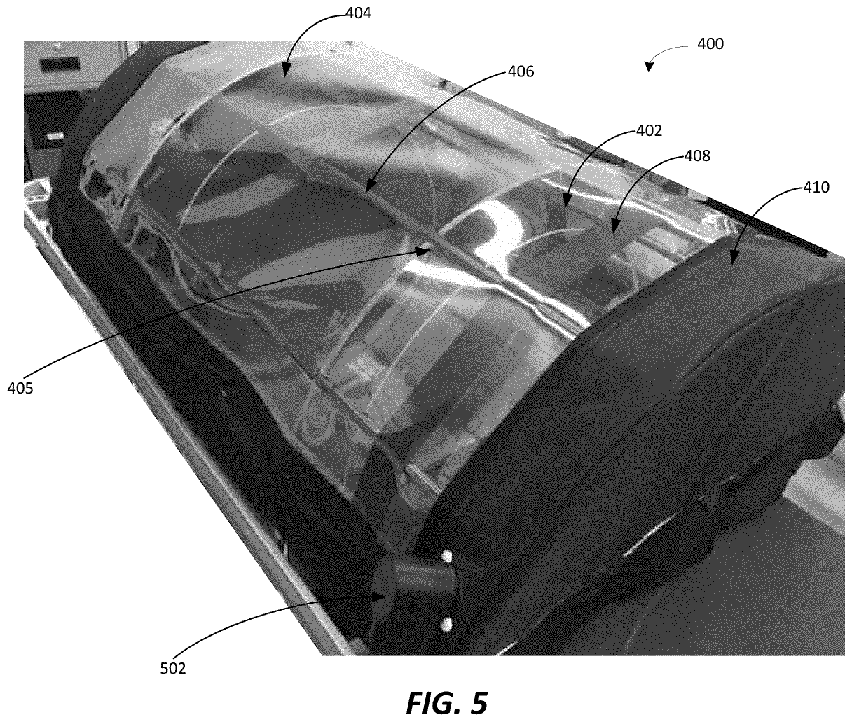

FIG. 4 and FIG. 5 illustrate perspective views of a lower body negative pressure device in accordance with one embodiment of the present disclosure. Referring to FIG. 4, lower body negative pressure device 400 includes internal frame 402 and flexible cover 410. Internal frame 402 may support flexible cover 410 when under negative pressure. Internal frame 402 may include arches 404 and rods 406. Arches 404 may support pressure from flexible cover 410 through rods 406. Arches 404 may be configured to receive rods 406 using cut outs 405. As illustrated, arches 404 may be made of polycarbonate.

Rods 406 may support internal frame 402 from negative pressure received from flexible cover 410. As illustrated, rods 406 may be made of carbon fiber. As described above, In some embodiments, internal frame 402 may include straps 408 to provide additional support for arches 404 and rods 406. In embodiments, straps 408 may be coupled, or otherwise attached, to flexible cover 410. Straps 408 may help prevent flexible cover 410 from collapsing under negative pressure.

Flexible cover 410 may provide a semi-permeable surface that covers internal frame 402. Flexible cover 410 may include a first portion 412 and a second portion 414. Flexible cover 410 may include transparent material, illustrated as vinyl window, on the top of flexible cover 410. The transparent material may allow someone to view the patient inside lower body negative pressure device 400 without having to remove the patient. As illustrated, the transparent material may be coupled to ripstop nylon, as described above. Flexible cover 410 may be able to transfer properties of a surface (e.g., hospital bed) in contact with flexible cover 410 to a patient inside lower body negative pressure device 400. Referring to FIG. 5, lower body negative pressure device 400 may include a pressure device port 502. The pressure device (FIG. 2) may be coupled to pressure device port 502 to generate the negative pressure in lower body negative pressure device 400.

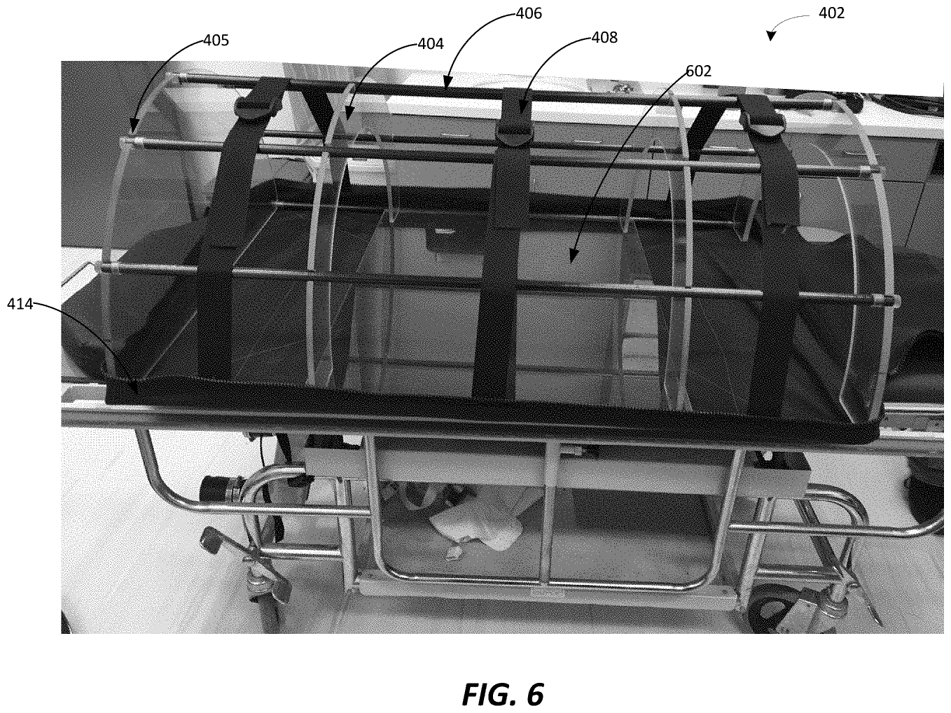

FIG. 6 illustrates a perspective view of an internal frame in accordance with one embodiment of the present disclosure. As described above, internal frame 402 may include arches 404, rods 406, and straps 408. As illustrated, internal frame 402 is resting on top of second portion 414. As illustrated, internal frame 402 may include base 602. Base 602 prevents the underside portion of flexible cover 410 from collapsing under negative pressure. Base 602 may be configured to receive arches 404 via cutouts in base 602. As illustrated, four cutouts are in base 602 to receive the four edges of the arches 404. The support (FIG. 1) may be coupled to the base to prevent the patient from being pulled into the lower body negative pressure device when activated.

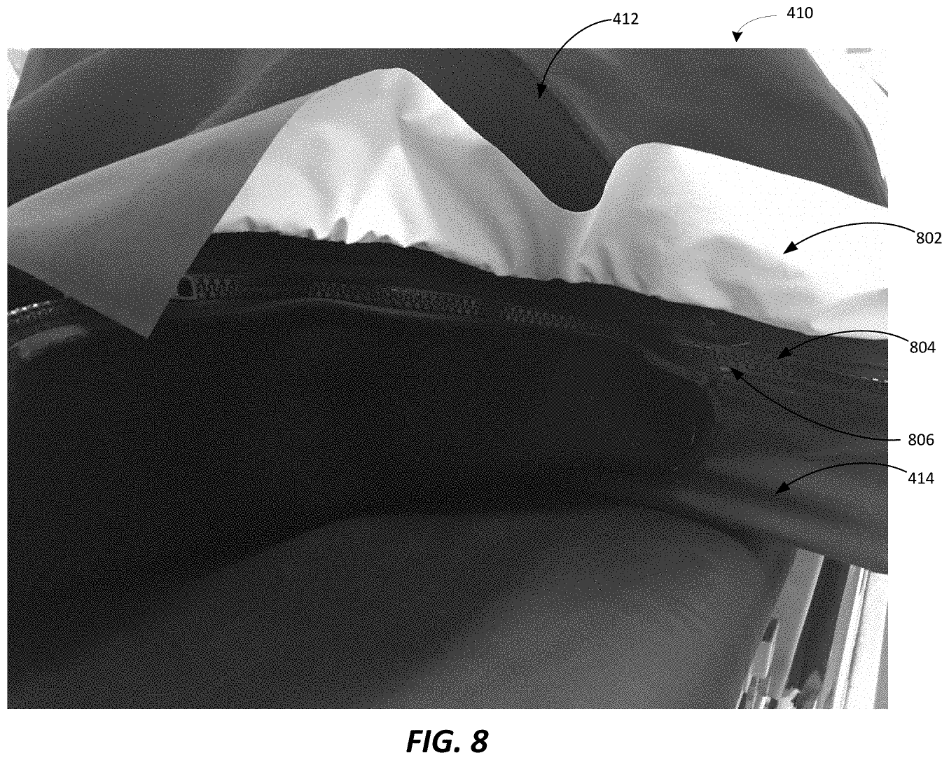

FIG. 8 illustrates a flexible cover in accordance with one embodiment of the present disclosure. As illustrated, flexible cover 410 includes first portion 412 and second portion 414. First portion 412 may include a first coupling element 804 and second portion 414 may include a second coupling element 806. First portion 410 may include extra material 802 to cover first coupling element 804 and second coupling element 806. First coupling element 804 may be a pull tab part of a zipper and the second coupling element corresponding to the first coupling element may be a slider part of a zipper. First coupling element 804 and second coupling element 806 may inadvertently leak air from the sealed environment within lower body negative pressure device 400 allowing air to enter from outside the device. Extra material 802 may improve the seal formed by flexible cover 410 because extra material 802 may lie flat against first coupling element 804 and second coupling element 806 when lower body negative pressure device 400 is activated. Extra material 802 may be the same material as first portion 410. Extra material 802 may be coupled to, or be a part of, first portion 412.

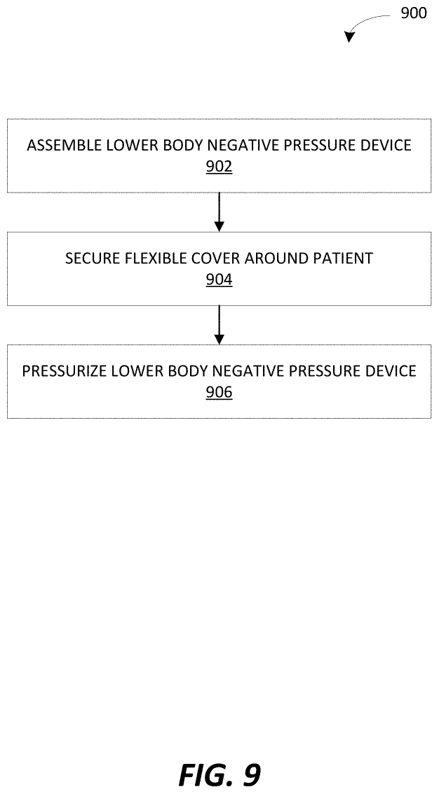

FIG. 9 is a flow chart illustrating example operations that can be performed to reduce intracranial pressure in accordance with various embodiments of the present disclosure. At operation 902, the lower body negative pressure device is assembled. As described above, the lower body negative pressure device may include an internal frame and a flexible cover. The lower body negative pressure device may be assembled over the patient. This may include placing a second portion of flexible cover under the patient, assembling the internal frame over the patient, and coupling the first portion of the flexible cover to the second portion of the flexible cover, for example, by zipping the first portion to the second portion.

At operation 904, the patient may be secured to the flexible cover to create a sealed environment. As described above, the tapered flexible opening may be secured, for example, through the use of Velcro®.

At operation 906, the lower body negative pressure device may be pressurized to reduce intracranial pressure. As described above, a control circuit may monitor biological metrics of the patient and metrics of the lower body negative pressure device through sensors to ensure safe usage of the lower body negative pressure device.

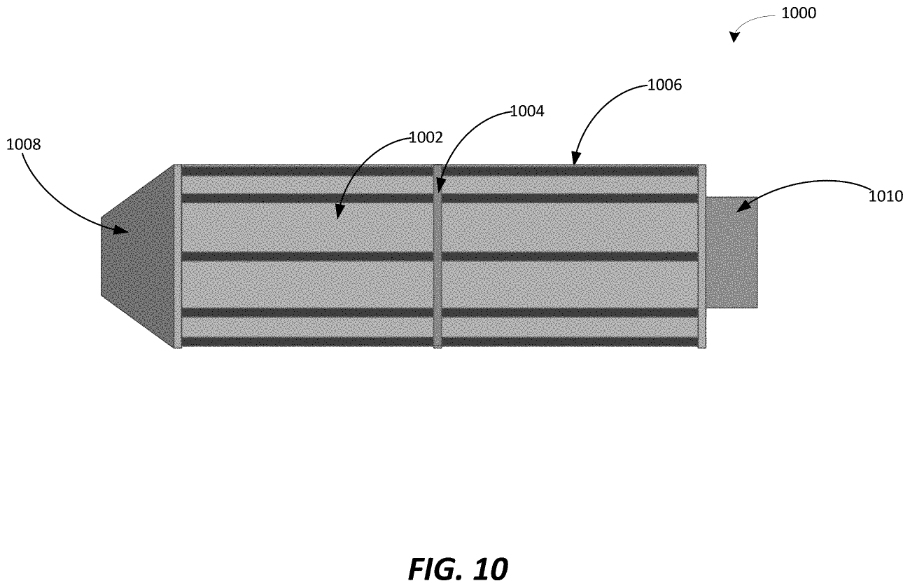

FIG. 10 illustrates a lower body negative pressure device 1000, in accordance with one embodiment of the present disclosure. In embodiments, lower body negative pressure device 1000 may cover only one extremity, such as a leg or an arm. In some embodiments, multiple lower body negative pressure devices 1000 may be used to cover multiple extremities. Instead of being configured to receive and secure a midsection of a patient, lower body negative pressure device 1000 may be configured to receive and secure a proximal side of an extremity. As described above, lower body negative pressure device 1000 may include an internal frame 1002, arches 1004, rods 1006, a flexible cover 1008, and a pressure device 1010, which may also include a battery, In some embodiments. Lower body negative pressure device 1000 may be substantially similar to the lower body negative pressure device described above.

FIG. 11 illustrates example computing module 1100, which may in some instances include a processor on a computer system (e.g., control circuit). Computing module 1100 may be used to implement various features and/or functionality of embodiments of the systems, devices, and methods disclosed herein. With regard to the above-described embodiments set forth herein in the context of systems, devices, and methods described with reference to FIGS. 1-10, including embodiments involving the control circuit, one of skill in the art will appreciate additional variations and details regarding the functionality of these embodiments that may be carried out by computing module 1100. In this connection, it will also be appreciated by one of skill in the art upon studying the present disclosure that features and aspects of the various embodiments (e.g., systems) described herein may be implemented with respected to other embodiments (e.g., methods) described herein without departing from the spirit of the disclosure.

As used herein, the term module may describe a given unit of functionality that may be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines, or other mechanisms may be implemented to make up a module. In implementation, the various modules described herein may be implemented as discrete modules or the functions and features described may be shared in part or in total among one or more modules. In other words, as would be apparent to one of ordinary skill in the art after reading this description, the various features and functionality described herein may be implemented in any given application and may be implemented in one or more separate or shared modules in various combinations and permutations. Even though various features or elements of functionality may be individually described or claimed as separate modules, one of ordinary skill in the art will understand upon studying the present disclosure that these features and functionality may be shared among one or more common software and hardware elements, and such description shall not require or imply that separate hardware or software components are used to implement such features or functionality.

Where components or modules of the application are implemented in whole or in part using software, in embodiments, these software elements may be implemented to operate with a computing or processing module capable of carrying out the functionality described with respect thereto. One such example computing module is shown in FIG. 10. Various embodiments are described in terms of example computing module 1100. After reading this description, it will become apparent to a person skilled in the relevant art how to implement example configurations described herein using other computing modules or architectures.

Referring now to FIG. 10, computing module 1100 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing module 1100 is specifically purposed.

Computing module 1100 may include, for example, one or more processors, controllers, control modules, or other processing devices, such as a processor 1110, and such as may be included in circuitry 1115. Processor 1110 may be implemented using a special-purpose processing engine such as, for example, a microprocessor, controller, or other control logic. In the illustrated example, processor 1110 is connected to bus 1155 by way of circuitry 1115, although any communication medium may be used to facilitate interaction with other components of computing module 1100 or to communicate externally.

Computing module 1100 may also include one or more memory modules, simply referred to herein as main memory 1115. For example, random access memory (RAM) or other dynamic memory may be used for storing information and instructions to be executed by processor 1110 or circuitry 1115. Main memory 1115 may also be used for storing temporary variables or other intermediate information during execution of instructions to be executed by processor 1110 or circuitry 1115. Computing module 1100 may likewise include a read only memory (ROM) or other static storage device coupled to bus 1155 for storing static information and instructions for processor 1110 or circuitry 1115.

Computing module 1100 may also include one or more various forms of information storage devices 1120, which may include, for example, media drive 1130 and storage unit interface 1135. Media drive 1130 may include a drive or other mechanism to support fixed or removable storage media 1125. For example, a hard disk drive, a floppy disk drive, a magnetic tape drive, an optical disk drive, a CD or DVD drive (R or RW), or other removable or fixed media drive may be provided. Accordingly, removable storage media 1125 may include, for example, a hard disk, a floppy disk, magnetic tape, cartridge, optical disk, a CD or DVD, or other fixed or removable medium that is read by, written to or accessed by media drive 1130. As these examples illustrate, removable storage media 1125 may include a computer usable storage medium having stored therein computer software or data.

In alternative embodiments, information storage devices 1120 may include other similar instrumentalities for allowing computer programs or other instructions or data to be loaded into computing module 1100. Such instrumentalities may include, for example, fixed or removable storage unit 1140 and storage unit interface 1135. Examples of such removable storage units 1140 and storage unit interfaces 1135 may include a program cartridge and cartridge interface, a removable memory (for example, a flash memory or other removable memory module) and memory slot, a PCMCIA slot and card, and other fixed or removable storage units 1140 and storage unit interfaces 1135 that allow software and data to be transferred from removable storage unit 1140 to computing module 1100.

Computing module 1100 may also include a communications interface 1150. Communications interface 1150 may be used to allow software and data to be transferred between computing module 1100 and external devices. Examples of communications interface 1150 include a modem or softmodem, a network interface (such as an Ethernet, network interface card, WiMedia, IEEE 1112.XX, or other interface), a communications port (such as for example, a USB port, IR port, RS232 port Bluetooth® interface, or other port), or other communications interface. Software and data transferred via communications interface 1150 may typically be carried on signals, which may be electronic, electromagnetic (which includes optical) or other signals capable of being exchanged by a given communications interface 1150. These signals may be provided to/from communications interface 1150 via channel 1145. Channel 1145 may carry signals and may be implemented using a wired or wireless communication medium. Some non-limiting examples of channel 1145 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 1115, storage unit interface 1135, removable storage media 1125, and channel 1145. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 1100 or a processor to perform features or functions of the present application as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. It will be apparent to one of skill in the art how alternative functional, logical or physical partitioning and configurations can be implemented to implement the desired features of the technology disclosed herein. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A lower body negative pressure device comprising:
an internal frame that surrounds a patient's lower body when the patient is in the lower body negative pressure device;
a flexible cover covering the internal frame to receive the patient and provide a sealable environment; and
a pressure device coupled to the sealable environment to generate and regulate a negative pressure in the sealable environment when the sealable environment is sealed.

2. The lower body negative pressure device of claim 1, wherein the pressure device comprises a pressure release mechanism, such that when the negative pressure of the sealable environment reaches a threshold value, the pressure release mechanism releases air from the sealable environment.

3. The lower body negative pressure device of claim 1, further comprising a biological feedback monitor comprising:
a sensor to monitor the sealable environment;
a biosensor to monitor a biological metric of the patient;
the pressure device to regulate the negative pressure in the sealable environment;
a processor coupled to the sensor, the bio sensor, and the pressure device; and
a non-transitory computer-readable medium coupled to the processor and storing instructions that, when executed, cause the processor to: adjust the negative pressure in the sealable environment, using the pressure device, to a predetermined value when the biological metric reaches a threshold value.

4. The lower body negative pressure device of claim 3, wherein the biological metric comprises a heart rate, a mean arterial pressure, a cerebral perfusion pressure, or an intracranial pressure.

5. The lower body negative pressure device of claim 3, wherein the sensor comprises a temperature sensor, a pressure sensor, or a humidity sensor.

6. The lower body negative pressure device of claim 1, wherein the lower body negative pressure device is transportable, such that an assembled lower body negative pressure device is used on the patient at a site of injury, and the assembled lower body negative pressure device is transportable to an ambulance, a hospital bed, and a MRI device.

7. The lower body negative pressure device of claim 1, wherein the internal frame comprises:
two or more rods to support the flexible cover; and
two or more arches to support the flexible cover and to receive the two or more rods.

8. The lower body negative pressure device of claim 7, wherein the internal frame further comprises a base to receive the two or more arches.

9. The lower body negative pressure device of claim 8, wherein the base comprises a support extending perpendicularly from the base to prevent an upper body of the patient from entering the lower body negative pressure device.

10. The lower body negative pressure device of claim 1, wherein the internal frame is collapsible into a volume of about 1 cubic ft.

11. The lower body negative pressure device of claim 1, wherein the flexible cover comprises:
a first portion comprising:
a transparent material to view the patient; and
a first coupling element; and
a second portion comprising:
a flexible material to translate properties of a surface in contact with the flexible material to a corresponding portion of the patient in contact the flexible material; and
a second coupling element that is couplable to the first coupling element;
wherein the flexible cover conforms to various midsections of different patients.

12. The lower body negative pressure device of claim 11, wherein the first coupling element is a pull tab part of a zipper and the second coupling element is a slider part of a zipper.

13. The lower body negative pressure device of claim 12, wherein the flexible cover is removable from the internal frame by unzipping the first coupling element from the second coupling element.

14. The lower body negative pressure device of claim 11, wherein the first portion further comprises: a non-permeable material that overlaps both the first coupling element and the second coupling element when the first portion is coupled to the second portion, such that when the lower body negative pressure device is pressurized, the non-permeable material creates a seal against the first coupling element and the second coupling element.

15. The lower body negative pressure device of claim 11, wherein the second portion is disposable.

16. The lower body negative pressure device of claim 1, wherein the flexible cover comprises one or more sealable ports to provide access to the patient.

17. A method for reducing intracranial pressure comprising:
assembling a lower body negative pressure device over a patient's lower body, wherein the lower body negative pressure device comprises:
an internal frame that surrounds a patient's lower body when the patient is in the device;
a flexible cover covering the internal frame to provide a sealable environment; and
a pressure device to generate and regulate a negative pressure when the sealable environment is sealed;
securing the flexible cover around the patient to create a sealed environment; and
pressurizing the lower body negative pressure device using the pressure device to reduce intracranial pressure in the patient.

18. The method of claim 15, further comprising releasing air from the sealable environment to reduce the negative pressure when the negative pressure of the sealable environment reaches a threshold value.

19. The method of claim 15, wherein the lower body negative pressure device further comprises a biological feedback monitor comprising:
a sensor to monitor the sealable environment;
a biosensor to monitor a biological metric of the patient;
a processor coupled to the sensor, the bio sensor, and the pressure device;
the pressure device to regulate the negative pressure in the sealable environment; and
a non-transitory computer-readable medium coupled to the processor and storing instructions that, when executed, cause the processor to: adjust the negative pressure in the sealable environment, using the pressure device, within a range of values when the biological metric reaches a threshold value.

20. An apparatus comprising:
an internal frame surrounding a patient's lower body when the patient is in the device;
a flexible cover covering the internal frame to receive the patient and to provide a sealable environment; and
a pressure device to generate and regulate a negative pressure when the sealable environment is sealed.
